(19) United States
(12) Patent Application Publication
(10) Pub. No.: US 2006/0101353 A1
(43) Pub. Date: May 11, 2006

(54) Multi-pane navigation model for graphical user interfaces

(75) Inventors: Bradford R. Clark, Duvall, WA (US); Vanessa Cristina Feliberti, Sammamish, WA (US)

Correspondence Address: SENNIGER POWERS, ONE METROPOLITAN SQUARE, 16TH FLOOR, ST. LOUIS, MO, 63102, US

(73) Assignee: Microsoft Corporation, Redmond, WA (US)

(21) Appl. No.: 11/333,164

(22) Filed: Jan. 17, 2006

(51) Int. Cl. G06F 17/00

(52) U.S. Cl. 715/792; 715/777; 715/854

(57) ABSTRACT

A graphical user interface for navigating a hierarchical tree of items wherein a top level pane, a first detail-level pane, and a second detail-level pane are utilized to display contents of tree items being navigated.

### BACKGROUND

Graphical user interfaces have been utilized to navigate complex hierarchies of items by providing a top-level navigation pane that comprises graphical representations of selectable items in a tree hierarchy. The navigation pane is utilized by users to navigate the hierarchy of items until a desired item is located. Once the desired item is selected, the contents of the item are displayed in a details pane.

While the graphical user interface may be useful in navigating trees that contain small numbers of items, once a tree contains a large number of items on numerous levels of hierarchy, the navigation pane must display so much information that the navigation of the tree becomes cumbersome. Furthermore, as the size and levels of the tree exceed the boundaries of the viewable area of the navigation pane, users can become lost when searching for items that are located outside the viewable area. Thus, working with items that are not all within the viewable area of the navigation pane at the same time impedes the efficiency of a user in locating the items.

The problems of the existing graphical user interfaces for traversing tree hierarchies becomes even more pronounced, when the navigation pane contains hundreds, thousands, or more items.

### SUMMARY

One or more deficiencies of the known art are overcome by methods of navigating a hierarchical tree by splitting the navigation pane into more than one pane. A top-level pane comprises a tree hierarchy of selectable items, a first detail-level window contains contents of an item selected in the top-level pane, and a second detail-level pane contains the contents of an item selected from the first detail-level pane.

Computer-readable media having computer-executable instructions for displaying items in a hierarchy and for navigating a hierarchy embody further aspects of the invention.

Alternatively, the invention may comprise various other methods and apparatuses.

Other features will be in part apparent and in part pointed out hereinafter.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an exemplary embodiment of a multiple pane navigation display wherein a second detail-level window comprises containers.

FIG. 2 is an illustration of an exemplary embodiment of a multiple pane navigation display wherein a second detail-level window contains objects.

FIG. 3 is a block diagram illustrating one example of a suitable computing system environment in which the invention may be implemented.

FIG. 4 is an illustration of a navigational hierarchy that exceeds the viewable area of a screen.

Corresponding reference characters indicate corresponding parts throughout the drawings.

### DETAILED DESCRIPTION

For purposes of the following description, items contained in a navigational hierarchy can be either containers or objects. Containers are items that contain either objects or other containers. In one common example, a container is a folder that can contain other folders or objects. Objects are an end point item of a tree, such as a file of executable code, a database file, and the like that can not be further traversed to other containers or objects.

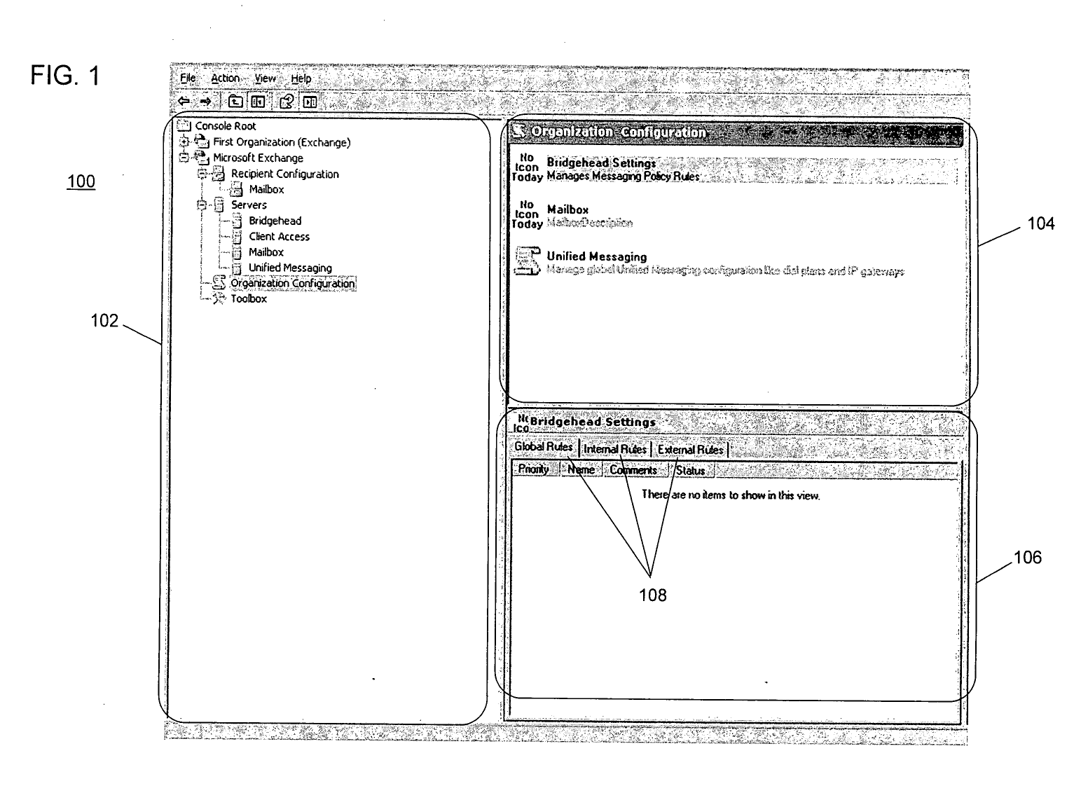

Referring first to FIG. 1, a display screen 100 illustrates exemplary embodiment of a multiple pane navigation display. Top-level pane 102 contains top levels of a navigational hierarchy of selectable items. For example, the top three, four, five, or six levels of a navigational hierarchy may be displayed. In the top-level pane, a container entitled, “Organization Configuration” is selected in the illustrated embodiment. Once a top-level container is selected, its contents are displayed in first detail-level pane 104. In this example, the container entitled, “Bridgehead Settings” is selected. The selection of a first detail-level container causes its contents to be displayed in second detail-level pane 106. If the contents of the selected first detail-level container also comprise containers and/or objects, the containers and/or objects are displayed in the second detail-level pane as a user interface component. If the first detail-level container comprises objects, the objects are displayed in the body of the second detail-level pane. In this example, the selected first detail-level container “Bridgehead Settings” contains three containers, “Global Rules,” “Internal Rules,” and “External Rules.” The second detail-level containers are displayed in second detail-level pane 106 as tabs 108. Once a tab 108 is selected, the contents of the selected second detail-level container are displayed in the body of the second detail-level pane. In this example, while the display indicates that there are no items to show in this view, the contents of a second detail-level container would be displayed in tabular form within second detail-level pane.

In another example, second detail-level containers and/or objects are displayed in second detail-level pane 106. If the second detail-level containers comprise objects and/or containers, the objects and/or containers can be displayed as subnodes under the second detail-level containers.

In one embodiment, the navigational graphical user interface can comprise more than one second detail-level pane 106. Each second detail-level pane 106 displays the contents of a different container selected in first detail-level pane 104.

In another embodiment, first detail-level pane 104 can comprise two or more navigational hierarchies. Each navigational hierarchy that is present in first detail-level pane 104 being displayed by a user interface component. Selection of such a user interface component in first detail-level pane 104 displays the navigational hierarchy of items. The selection of an item on a tree contained in first detail-level pane displays the contents of the selected item in second detail-level pane 106.

In another embodiment, the navigational hierarchy contained in top-level pane 102 is limited to a specific number of levels. In one example, as illustrated in FIG. 1, the navigational hierarchy contained in top-level pane 102 is limited to a depth of four levels. By limiting the number of levels that can be displayed in the top-level pane, a user can see multiple levels on a single viewable screen in the displayed first and second detail-level panes.

In another example, top-level navigation pane 102 is limited to a depth of three, five, or six levels.

In another embodiment, a selection of a different item in any of top level-pane 102, first detail-level pane 104, or second detail-level pane 106, results in the contents of lower detail panes to change. For example, selecting a different item in top-level pane 102 causes the contents of first detail-level pane 104 and second detail-level pane 106 to change. Alternatively, the selection of a different item in first detail-level pane 104 causes the contents of second detail-level pane 106 to change.

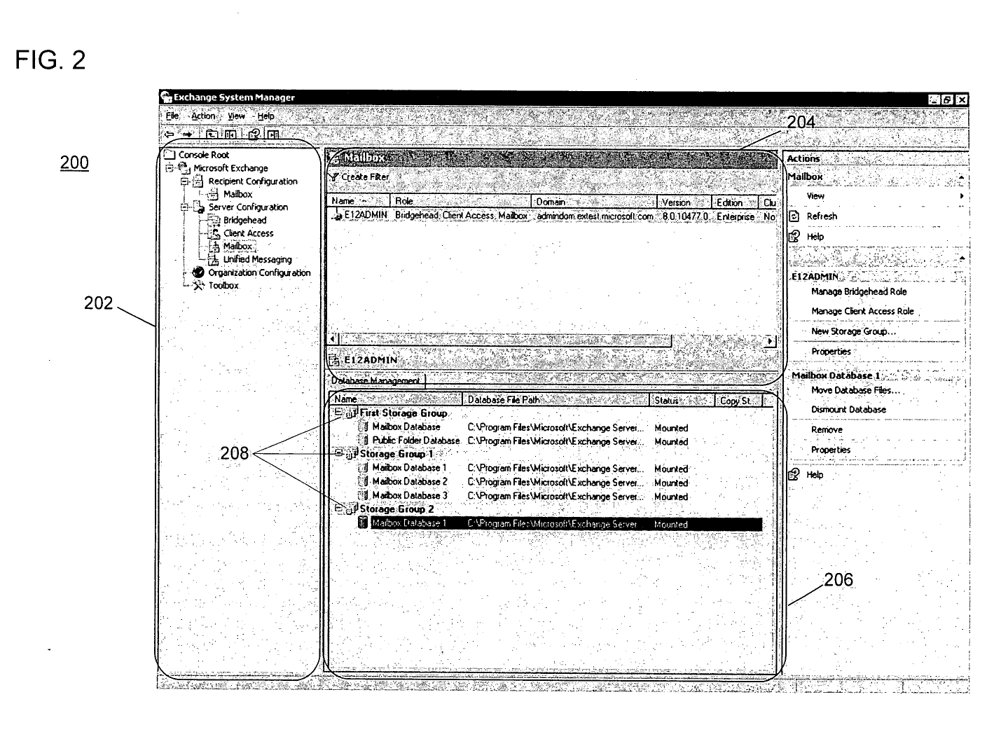

Referring next to FIG. 2, a display screen 200 illustrates another exemplary embodiment of a multiple pane navigation display. Similar to the multiple pane navigation display illustrated in FIG. 1, Top-level pane 202 contains top levels of a navigational hierarchy of selectable items. Once a top-level container is selected, its contents are displayed in first detail-level pane 204. In this example, the container entitled, “E12ADMIN” is selected. The selection of a first detail-level container causes its contents to be displayed in second detail-level pane 206. In this example, the contents of E12ADMIN are objects 208 which are servers (First Storage Group, Storage Group 1, and Storage Group 2). The databases associated with each server are listed under their respective server.

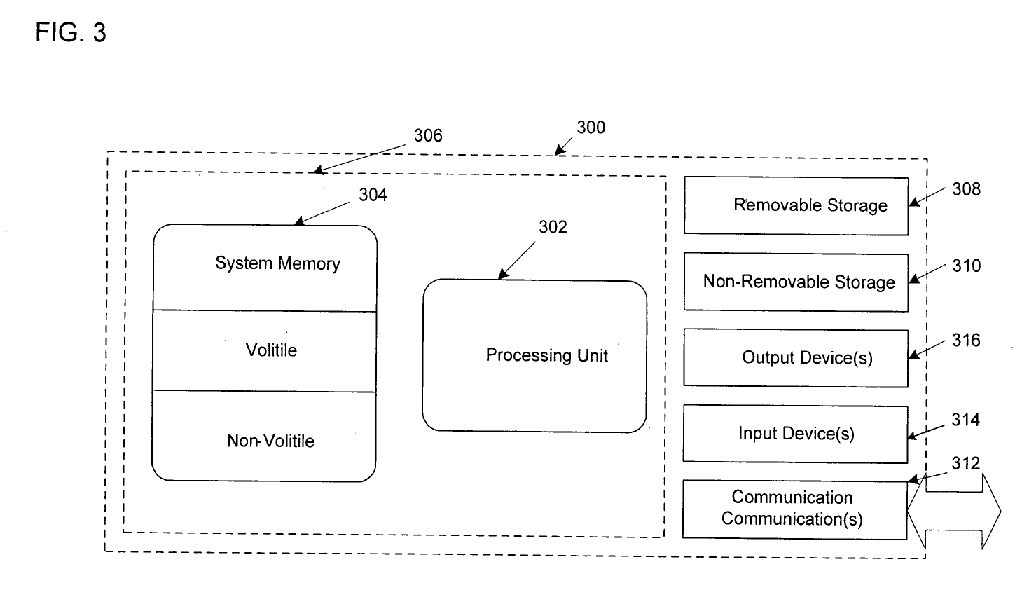

FIG. 3 is a block diagram illustrating one example of a suitable computing system environment in which the invention may be implemented, which includes a computing device, such as computing device 300. In its most basic configuration, computing device 300 typically includes at least one processing unit 302 and memory 304. Depending on the exact configuration and type of computing device, memory 304 may be volatile (such as RAM), non-volatile (such as ROM, flash memory, etc.) or some combination of the two. This most basic configuration is illustrated in FIG. 3 by dashed line 306. Additionally, device 300 may also have additional features/functionality. For example, device 300 may also include additional storage (removable and/or non-removable) including, but not limited to, magnetic or optical disks or tape. Such additional storage is illustrated in FIG. 3 by removable storage 308 and non-removable storage 310. Computer storage media includes volatile and nonvolatile, removable and non-removable media implemented in any method or technology for storage of information such as computer readable instructions, data structures, program modules or other data. Memory 304, removable storage 308 and non-removable storage 310 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 300. Any such computer storage media may be part of device 300.

Device 300 may also contain communications connection(s) 312 that allow the device to communicate with other devices. Communications connection(s) 312 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 300 may also have input device(s) 314 such as keyboard, mouse, pen, voice input device, touch input device, etc. Output device(s) 316 such as a display, speakers, printer, etc. may also be included. All these devices are well know in the art and need not be discussed at length here.

The following examples further illustrate the invention.

### EXAMPLE 1

In existing graphical user interfaces it is common to split the viewable work area of the user display screen into several panes. One of these panes is allocated to object navigation and others reflect details, most often about the selected item in the navigation pane.

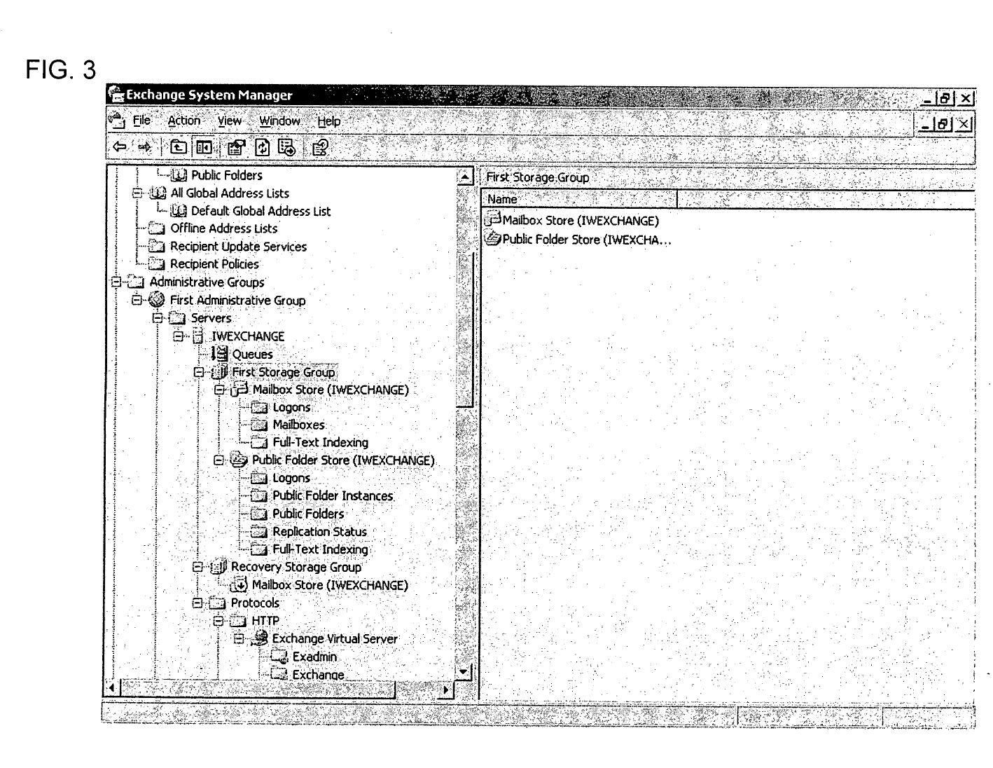

One significant problem with this model is that the navigation pane needs to represent so much information that users can get lost as the items they wish to work with fall off the viewable area of the navigation pane. An illustration of this problem may be seen in FIG. 4, wherein an expanded navigational hierarchy comprises numerous expanded levels of containers and objects, causing the only a portion of the hierarchy to be displayed on a screen at one time. Working with items that are not ‘within viewing distance’ (i.e. do not appear on the screen at the same time) severely impedes their ability to work effectively with those objects. In large and complex systems the navigation pane can contain hundreds of thousands of items.

Aspects of the present invention split the navigation pane into more than one window—a traditional navigation pane that represents the top portion of the navigation tree, and a new ‘detail level’ navigation pane. Conceptually the navigation pane continues to hold the top level navigation, and the ‘detail level’ pane(s) hold the lower level details. This approach solves the problem of working with objects that have fallen outside ‘viewing distance’ by allowing a larger portion of the main navigation pane to be visible. To paraphrase an old adage, it allows the user to still see the trees while in the forest.

Filter-based solutions will still work with embodiments of the invention, but are less essential.

In one example, the top-level navigation pane (the ‘forest pane’) continues to appear on the screen where it typically does (usually on the left side), the first detail-level navigation pane (the “Tree pane”) and the second detail-level (the “Branch pane(s)”) can appear elsewhere on the screen and provide more detail.

In the example illustrated in FIG. 1, in the absence of the present invention from this view alone you can see that the top-level navigation pane would have had at least two more levels, the levels necessary to hold the “Global Rules”, “Internal Rules”, and “External Rules” associated with “Bridgehead settings”.

As with any navigation pane, changes to either the top-level pane (“Forest pane”), or first detail-level pane (“Tree pane”) can be immediately reflected in any of the other lower level panes.

It is important to note that there can be several second detail-level (“Branch Panes”), each positioned on different items, or even item types, which dramatically increases the probability that all the items the user wishes to work will can be “within viewing distance” (i.e., on the same screen at the same time). Furthermore each first detail-level pane (“Tree pane”) can be of arbitrary depth or complexity. In the above example, the tree pane is quite simple, but it may itself be a tree, multi-tree (tree view where the trees are independently selectable through a user interface component such as ‘tabs’), tabular, as is illustrated, tabular with tabs, or any other type of pane.

The order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein. For example, it is contemplated that executing or performing a particular element before, contemporaneously with, or after another element is within the scope of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. In a computer system having a graphical user interface including a display and a user interface selection device, a method for displaying selectable items in a hierarchy, the method comprising:
defining at least three panes;
displaying a plurality of selectable top-level containers in a top-level pane, said top-level containers being displayed in a navigational hierarchy;
displaying at least one selectable first detail-level container in a first detail-level pane, wherein the first detail container is derived from a top-level container selected from the top-level pane;
displaying at least one selectable detail-level object in a second detail-level pane, wherein the detail-level object is derived from a first detail-level container selected from the first-level pane.

2. The method of claim 1, wherein the selected first detail-level container comprises a second detail-level container.

3. The method of claim 2, further comprising:
selecting the first detail-level container; and
displaying a selectable tab, table, or table of selectable tabs in the second detail-level pane, said selectable tab representing a second detail-level container derived from the first detail-level container.

4. The method of claim 3, further comprising:
selecting a tab representing the second detail-level container; and
displaying a detail-level object derived from the second detail-level container in the second detail-level pane.

5. The method of claim 1, further comprising displaying a plurality of second detail-level panes.

6. The method of claim 5, wherein the plurality of second detail-level panes contain objects or containers independently derived from a plurality of first detail-level containers selected from the first detail-level pane.

7. The method of claim 1, further comprising:
selecting a top-level container in the top-level pane; and
displaying a set of selectable first detail-level containers in the first detail-level pane, said set of selectable first detail-level containers comprising a first detail-level root container displayed in a tree hierarchy, the first detail-level root container corresponding to the selected top-level container.

8. The method of claim 1, further comprising:
selecting a top-level container in the top-level pane; and
displaying two or more first detail-level tree hierarchies in the first detail-level pane, wherein the tree hierarchies are derived from the selected top-level container.

9. The method of claim 8, wherein the first detail-level tree hierarchies are independently selectable.

10. The method of claim 8, wherein the first detail-level tree hierarchies are displayed in the first detail-level pane by a selectable user interface component, wherein the selectable user interface component is selected from the group comprising selectable tabs, selectable table, and selectable table comprising tabs.

11. The method of claim 10, further comprising:
selecting the selectable user interface component; and
displaying a first detail-level tree comprising a set of selectable first detail-level containers in the first detail-level pane, the first detail-level tree being derived from the selected user interface component.

12. The method of claim 1, wherein one or more computer-readable media have computer-executable instructions for performing the computer-executable method of claim 1.

13. A method of navigating a hierarchy of selectable items in a top-level pane, the method comprising:
selecting a top-level item in the top-level pane;
displaying a first detail-level pane comprising at least one selectable first detail-level item derived from the selected top-level item;
selecting a first detail-level item in the first detail-level pane;
displaying a second detail-level pane comprising at least one selectable second detail-level item derived from the selected first detail-level item.

14. The method of claim 13, wherein the selected first detail-level item is a first detail-level container comprising at least one second detail-level container.

15. The method of claim 14, wherein a selectable tab that corresponds to the second detail-level container is displayed in the second detail-level pane.

16. The method of claim 15, further comprising:
selecting the second detail-level tab; and
displaying, in the second detail-level pane, one or more objects that correspond to the selected second detail-level tab.

17. The method of claim 13, wherein selecting a second top-level item changes the items displayed in the first detail-level pane and the second detail-level pane.

18. A computer readable medium having computer-executable instructions for performing a method comprising:
providing a top-level pane for displaying a tree hierarchy of selectable items;
providing a first detail-level pane for displaying at least one first detail-level item linked to one of the items in the tree hierarchy of the top-level pane;
providing one or more second detail-level panes wherein each second detail-level pane displays one or more selectable tabs linked to the first detail-level item, said selectable tabs each representing a container of one or more second detail-level objects; and
displaying the contents of a selected tab in the second detail-level pane.

19. The computer-readable medium of claim 18, wherein the first detailed-level pane comprises one or more tree hierarchies of items.

20. The computer-readable medium of claim 19 further comprising:
displaying the first detail-level tree hierarchies in the first detail-level pane by a selectable user interface component, wherein the selectable user interface component is selected from the group comprising selectable tabs, selectable table, and selectable table comprising tabs.
